(19) United States
(12) Patent Application Publication
(10) Pub. No.: US 2017/0308925 A1
(43) Pub. Date: Oct. 26, 2017

(54) VIDEO SURVEY

(71) Applicant: Bully Pulpit Interactive, LLC, Washington, DC (US)

(72) Inventors: Michael Schneider, Washington, DC (US); Andrew Bleeker, Washington, DC (US); Daniel Scarvalone, Washington, DC (US)

(21) Appl. No.: 15/455,057

(22) Filed: Mar. 9, 2017

Related U.S. Application Data
(60) Provisional application No. 62/305,916, filed on Mar. 9, 2016.

(51) Int. Cl. G06Q 30/02; H04N 21/442; H04N 21/81

(52) U.S. Cl. CPC G06Q 30/0245; H04N 21/812; H04N 21/44222; G06Q 30/0251

(57) ABSTRACT

Provided herein are systems and methods for measuring effectiveness of an advertising campaign. Measurement of persuasion metrics, rather than engagement metrics, may provide more meaningful data on understanding how brands are actually moving their audience over time.

### CROSS-REFERENCE

This application claims priority to U.S. Provisional Application No. 62/305,916 filed on Mar. 9, 2016, which application is entirely incorporated herein by reference.

### BACKGROUND

The ability to measure persuasive effect of an advertising campaign on an individual level has traditionally been lacking. Instead, advertisers have been reliant on proxy metrics such as website visits, time on site, impressions, and video completions in measuring effectiveness of advertising campaigns. While useful in some contexts, the proxy metrics may fail to provide information on what moves the persuadable, undecided, audience. The ability to measure persuasion on an individual level may be critical for advertisers.

The present disclosure provides systems and methods that enable advertisers to evaluate effectiveness of advertising campaigns based on persuasion metrics that measure factors such as message recall, issue favorability, and intent to take action. The system and methods may utilize aggregate data gathered for an individual across a plurality of different advertising platforms and across multiple channels. The understanding of persuasion metrics may help advertisers increase the impact of paid and owned content, know what moves a persuadable audience, and get actionable and measurable results.

### SUMMARY

A need exists for systems and methods configured to measure effectiveness of advertising campaigns for individuals or a group of targets. The effectiveness of the advertising campaigns may be measured based on persuasion metrics. In some instances, effectiveness of advertisement campaigns may be measured based on answers provided in response to surveys. The surveys may be embedded within an interactive video, e.g., a pre-roll video. The surveys may be delivered across a plurality of different advertisement platforms and/or across a plurality of different channels. In some instances, the surveys may be delivered after satisfaction of a set criteria, such as a threshold number of advertisements delivered to the target. The surveys embedded within the interactive videos may have a high response rate, measure cumulative effectiveness of an advertisement campaign over time and across different platforms or channels, and mitigate against self-selection bias.

Thus, in one aspect, a method of delivering a survey in a video to a target user browsing a website is provided. The method comprises: receiving a list at a server, wherein the list comprises information regarding the target user; causing advertisements to be delivered to the target user, wherein the advertisements are caused to be delivered to the target user via a plurality of different advertising platforms; tracking data from the plurality of different advertising platforms regarding advertisements delivered to the target user; and causing the survey to be delivered to the target user browsing the website after satisfaction of a set criteria with respect to the tracked data, wherein the survey is delivered in the video.

In some embodiments, the tracked data is stored in a central database.

In some embodiments, the advertisements are caused to be delivered across a plurality of different channels. In some embodiments, the plurality of different channels are a plurality of different websites. In some embodiments, the plurality of different channels are a plurality of different devices. In some embodiments, the plurality of different channels are a plurality of different advertising mediums.

In some embodiments, data regarding advertisements delivered to the target user is tracked based on advertisements delivered to an anonymous user ID associated with the target user. In some embodiments, the user ID comprises no personally identifiable information (PII) of the target user. In some embodiments, the user ID is correlated to online-cookies associated with the target user. In some embodiments, the user ID is correlated to a mobile device ID associated with the target user. In some embodiments, the survey is caused to be delivered to the user ID associated with the target user.

In some embodiments, the information regarding the target user comprises personally identifiable information (PII) of the target user. In some embodiments, the PII comprises a name or address of the target user. In some embodiments, the PII comprises an email address of the target user. In some embodiments, the PII comprises demographic information of the target user.

In some embodiments, the tracked data comprises data regarding video advertisements delivered to the target user.

In some embodiments, the tracked data comprises data regarding a length of video advertisements viewed by the target user.

In some embodiments, the survey is delivered in a pre-roll video.

In some embodiments, the set criteria is a set period of time after delivery of at least one advertisement.

In some embodiments, the set criteria is a total length of advertisements viewed by the target user.

In some embodiments, the method further comprises joining the data tracked with additional data. In some embodiments, the additional data is configured to provide other types of information regarding the target user.

In some embodiments, the list comprises information regarding a plurality of target users. In some embodiments, the method further comprising dividing the plurality of target users into a plurality of different audience groups. In some embodiments, a different advertisement campaign is delivered to each of the different audience groups. In some embodiments, the different advertisements campaigns differ in a number of advertisements, a type of advertisements, or a sequence of advertisements delivered to the target user. In some embodiments, the method further comprises organizing the tracked data by the different audience groups. In some embodiments, the method further comprises measuring an effectiveness of the advertisement campaign delivered to each of the different audience groups.

In some embodiments, the survey contains a question and a list of potential answers.

In some embodiments, questions or answers within the survey are configured to be rotated or randomized.

In some embodiments, the method further comprises receiving a response to the survey. In some embodiments, the method further comprises measuring an effectiveness of the advertisement campaign based on a response of the target user to the survey. In some embodiments, the method further comprises associating the answer to the survey with a user ID associated with the target user. In some embodiments, the user ID comprises no personally identifiable information (PII) of the target user. In some embodiments, the method further comprises attributing the response to an audience group.

In another aspect, a non-transitory computer-readable medium for delivering a survey in a video to a target user browsing a website is provided. The non-transitory computer readable medium stores instructions executable by one or more processors of a processing device, which upon such execution cause the one or more processors to perform a method comprising: receiving a list at a server, wherein the list comprises information regarding the target user; causing advertisements to be delivered to the target user, wherein the advertisements are caused to be delivered to the target user via a plurality of different advertising platforms; tracking data from the plurality of different advertising platforms regarding advertisements delivered to the target user; and causing the survey to be delivered to the target user browsing the website after satisfaction of a set criteria with respect to the tracked data, wherein the survey is delivered in the video.

In another aspect, a system for delivering a survey in a video to a target user browsing a website is provided. The system comprises: one or more processors, individually or collectively configured to: receive a list at a server, wherein the list comprises information regarding the target user; cause advertisements to be delivered to the target user, wherein the advertisements are caused to be delivered to the target user via a plurality of different advertising platforms; track data from the plurality of different advertising platforms regarding advertisements delivered to the target user; and cause the survey to be delivered to the target user browsing the website after satisfaction of a set criteria with respect to the tracked data, wherein the survey is delivered in the video.

In another aspect, a method of delivering a survey in a video to a target user browsing a website is provided. The method comprises: receiving a list at a server, wherein the list comprises information regarding the target user; causing advertisements to be delivered to the target user; tracking data regarding advertisements delivered to the target user; and causing the survey to be delivered to the target user browsing the website, wherein the survey is delivered after a threshold number of advertisements has been delivered to the target user, and wherein the survey is delivered in the video.

In some embodiments, the threshold number is equal to or more than 4.

In some embodiments, the threshold number is equal to or more than 50.

In some embodiments, data regarding advertisements delivered to the target user is tracked based on advertisements delivered to a user ID associated with the target user. In some embodiments, the user ID comprises no personally identifiable information (PII) of the target user. In some embodiments, the user ID is correlated to online-cookies associated with the target user. In some embodiments, the user ID is correlated to a mobile device ID associated with the target user. In some embodiments, the survey is caused to be delivered to the user ID associated with the target user.

In some embodiments, the information regarding the target user comprises personally identifiable information (PII) of the target user. In some embodiments, the PII comprises a name or address of the target user. In some embodiments, the PII comprises an email address of the target user. In some embodiments, the PII comprises demographic information of the target user.

In some embodiments, wherein the tracked data comprises data regarding video advertisements delivered to the target user.

In some embodiments, the tracked data comprises data regarding a length of video advertisements viewed by the target user.

In some embodiments, the tracked data comprises data regarding a number of video advertisements delivered to the target user.

In some embodiments, the survey is delivered in a pre-roll video.

In some embodiments, the method further comprises joining the data tracked with additional data. In some embodiments, the additional data is configured to provide other types of information regarding the target user.

In some embodiments, the list comprises information regarding a plurality of target users. In some embodiments, the method further comprises dividing the plurality of target users into a plurality of different audience groups. In some embodiments, a different advertisement campaign is delivered to each of the different audience groups. In some embodiments, different advertisements campaigns differ in a number of advertisements, a type of advertisements, or a sequence of advertisements delivered to the target user. In some embodiments, the method further comprises measuring an effectiveness of the advertisement campaign delivered to each of the different audience groups. In some embodiments, the method further comprises organizing the tracked data by the different audience groups.

In some embodiments, the survey contains a question and a list of potential answers.

In some embodiments, questions or answers within the survey is configured to be rotated or randomized.

In some embodiments, the method further comprises receiving a response to the survey. In some embodiments, the method further comprises associating the answer to the survey with a user ID associated with the target user. In some embodiments, the user ID comprises no personally identifiable information (PII) of the target user.

In some embodiments, the method further comprises attributing the response to an audience group.

In another aspect, a non-transitory computer-readable medium for delivering a survey in a video to a target user browsing a website is provided. The non-transitory computer readable medium stores instructions executable by one or more processors of a processing device, which upon such execution cause the one or more processors to perform a method comprising: receiving a list at a server, wherein the list comprises information regarding the target user; causing advertisements to be delivered to the target user; tracking data regarding advertisements delivered to the target user; and causing the survey to be delivered to the target user browsing the website, wherein the survey is delivered after a threshold number of advertisements has been delivered to the target user, and wherein the survey is delivered in the video.

In another aspect, a system for delivering a survey in a video to a target user browsing a website is provided. The system comprises: one or more processors, individually or collectively configured to: receive a list at a server, wherein the list comprises information regarding the target user; cause advertisements to be delivered to the target user; track data regarding advertisements delivered to the target user; and cause the survey to be delivered to the target user browsing the website, wherein the survey is delivered after a threshold number of advertisements has been delivered to the target user, and wherein the survey is delivered in the video.

In another aspect, a method of delivering a survey in a video to a target user browsing a website is provided. The method comprises: receiving a list at a server, wherein the list comprises information regarding the target user; sending instructions to a plurality of different advertising platforms, wherein the instructions cause advertisements to be delivered to the target user; tracking data from the plurality of different advertising platforms, wherein the data comprises information regarding advertisements delivered to the target user; and causing the survey to be delivered to the target user browsing the website after satisfaction of a set criteria with respect to the tracked data, wherein the survey is delivered in a video.

In another aspect, a method of delivering a survey in a video to a target user browsing a website is provided. The method comprises: receiving a list at a server, wherein the list comprises information regarding the target user; sending instructions to an advertising platform, wherein the instructions cause advertisements to be delivered to the target user; tracking data from the advertising platform regarding advertisements delivered to the target user; and causing the survey to be delivered to the target user browsing the website after a threshold number of advertisements has been delivered to the target user, wherein the survey is delivered in a video.

In another aspect, a method of delivering a survey in a video to a target user browsing a website is provided. The method comprises: receiving a list at a server, wherein the list comprises information regarding the target user; sending instructions to a plurality of different advertising platforms, wherein the instructions cause advertisements to be delivered to the target user; tracking data from the plurality of different advertising platforms, wherein the data comprises information regarding advertisements delivered to the target user; and delivering the survey to be delivered to the target user browsing the website after satisfaction of a set criteria with respect to the tracked data, wherein the survey is delivered in the video.

In another aspect, a method of delivering a survey in a video to a target user browsing a website is provided. The method comprises: receiving a list at a server, wherein the list comprises information regarding the target user; sending instructions to an advertising platform, wherein the instructions cause advertisements to be delivered to the target user; tracking data from the advertising platform regarding advertisements delivered to the target user; and delivering the survey to be delivered to the target user browsing the website after a threshold number of advertisements has been delivered to the target user, wherein the survey is delivered in the video.

In another aspect, a method of delivering a survey is provided. The method comprises: causing advertisements to be delivered to a target user, wherein the advertisements are caused to be delivered to the target user via a plurality of different advertising platforms; tracking data from the plurality of different advertising platforms regarding advertisements delivered to the target user; and causing the survey to be delivered to the target user browsing a website after satisfaction of a set criteria with respect to the tracked data, wherein the survey is delivered in a video.

In another aspect, a method of delivering a survey is provided. The method comprises: causing advertisements to be delivered to a target user; tracking data regarding advertisements delivered to the target user; and causing the survey to be delivered to the target user browsing a website, wherein the survey is delivered after a threshold number of advertisements has been delivered to the target user, and wherein the survey is delivered in a video.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates a schematic for mapping targeted users to their online personas, in accordance with embodiments.

FIG. 2 illustrates a schematic of an advertising campaign set up for an online persona (e.g., a target user), in accordance with embodiments.

FIG. 3 illustrates an exemplary survey presented in a pre-roll video, in accordance with embodiments.

FIG. 4 illustrates a method of delivering a survey, in accordance with embodiments.

FIG. 5 illustrates a method for delivering a survey based on data tracked across a plurality of different platforms, in accordance with embodiments.

FIG. 6 illustrates a method for delivering a survey after a threshold number of advertisements have been delivered to the target user, in accordance with embodiments.

FIG. 7 illustrates a video survey delivered to an individual, in accordance with embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

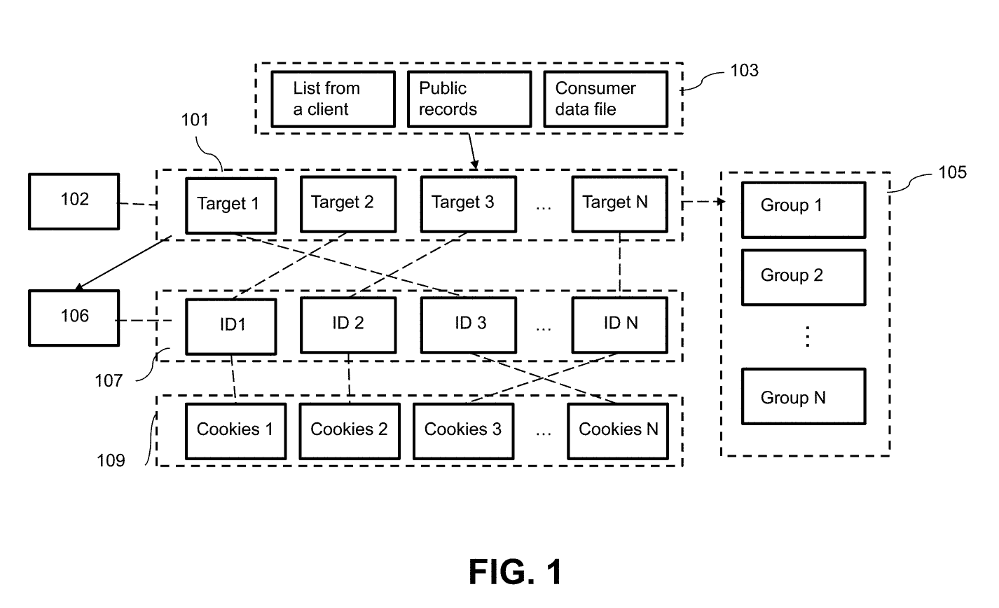

FIG. 1 illustrates a schematic for mapping targeted users to their online personas, in accordance with embodiments. In some instances, online personas that have been mapped to target users may be targeted, e.g., for advertising or for being surveyed. In some instances, a list of target individuals 101 may be received by a party 102. The list of target individuals, herein also referred to as a list or a record, may originate from any number of sources 103. For example, the list may be derived from a client file. In some instances, the list may be derived from a consumer data file (e.g., from an information services group), from a customer relationships management file within a company (e.g., a company's list of customers), from publicly available records (e.g., voter file). The list may be in the form of a batch record. The list may comprise information regarding any number of target individuals. For example, the record may comprise information regarding about 5, 10, 50, 100, 200, 500, 1000, 1500, 2000, 5000 or more individuals.

The list of target individuals may comprise any record, data, and/or information associated with the target individuals. In some instances, the list of target individuals may comprise personally identifiable information (PII) that can be used to connect a target individual within the list to their identity. In some instances, the list may comprise information that can identify a specific individual. In some instances, the list may comprise information that can be used to distinguish one person from another. For example, the list may comprise information associated with a real-life identity of the target individual such as a name, address, telephone number, or email address of the target individual. For example, the list may comprise demographic information such as age, gender, income (e.g., household income), education level, job function, ethnicity, political affiliation, marital status, employment status, perceived socio-economic status, etc of the target individual. In some instances, the record received from the client may comprise information comprising at least one of (1) a name and address of the target individual(s), or (2) an email address of the target individual(s).

In some instances, the list may be divided into a plurality of different experimental groups 105 also referred to herein as audience groups. The list may be divided into any number of experimental groups, e.g., 1, 2, 3, 4, 5, 10, 15, 20, 30, 50, 100 or more experimental groups. Each experimental group may comprise information regarding about at least 1, 2, 5, 10, 20, 50, 100, 200, 500, 1000, 2000, 5000, or more target individuals. In some instances, the division of the experimental groups (e.g., determination of which target individual goes in which experimental group) may be random. In some instances, the division of the experimental groups may be based on predetermined criteria. For example, the division of experimental groups may be based on demographic information such as age, gender, income (e.g., household income), education level, job function, ethnicity, political affiliation, marital status, employment status, perceived socio-economic status, and the like. In some instances, the division of experimental groups may be based a plurality of different factors, e.g., on gender and household income.

The list of target individuals may be matched to their corresponding online personas. For example, the list 101 may be sent to a matching partner (MP) 106. In some instances, the list of target individuals may be sent to the matching partner organized by the different experimental groups 105. The matching partner may map each individual within the list to key IDs 107. The IDs may be pre-existing within the matching partner's database. In some instances, the IDs may be generated for a target individual. For example, the IDs within the MP's database may be pre-associated with information regarding individuals (e.g., email address, name, address, etc). Based on information within the list, relevant IDs may be identified. The relevant IDs may correspond to, or be associated with, target individuals. In some instances, for an individual that cannot be matched to an ID within its database, the matching partner may generate a new ID to map the individual to. In some instances, each ID within the database may be unique.

The IDs may be mapped to an online persona 109 of the target individual. An online persona as described herein may enable different entities or websites to recognize and/or keep track of online activities of the target individual. In some instances, the IDs may be pre-associated with the appropriate online personas, e.g., based on information gathered by the MP. In some instances, the matching partner may update IDs with appropriate online personas, e.g., based on information gathered by the MP. An online persona of the target individual may individual or collectively comprise online-cookies, device IDs (e.g., mobile device IDs), website-specific login information, and the like associated with the target individual. In some instances, the IDs may be mapped to (e.g., be associated with) online-cookies, device IDs, website-specific login information, and the like associated with the target individual. In some instances, a plurality of different online-cookies may be mapped to a single target individual. The plurality of cookies may correspond to different devices (e.g., desktop computer, laptop computer, PDA, cell phone, tablet, etc) used by the target individual. The plurality of cookies may correspond to different websites used by the target individual. In some instances, the IDs may be mapped to a plurality of different advertising platform-specific IDs. Each of the advertising platform-specific IDs may comprise online-cookies, device IDs (e.g., IDFA or AAID), website-specific login information (e.g., social profile ID), and the like associated with the target individual.

In some instances, other information may be sent to the matching partner 106 from the party 102. For example, desired advertising platforms to use in causing advertisements to be sent to the targeted users may be sent to the matching partner. Based on the information, the matching partner may transmit a segment of relevant IDs to each of the desired advertising platforms to be associated with the advertising platform-specific IDs. The segment of relevant IDs, herein also referred to as the segment, may comprise no personally identifiable information of the target individuals. In some instances, the segment may be completely anonymous and may be referred to as the anonymous segment. The segment may lack any PII but may be utilized in identifying an online persona as being a targeted individual. In some instances, the segment may comprise online-cookies.

In some instances online personas may be targeted (e.g., for advertising or for being surveyed) without having been mapped to specific target individuals in a list. For example, an ad impression may be delivered to an online persona, e.g., a user browsing a website. At time of the ad impression delivery, relevant user information regarding the online persona may be captured. Relevant user information regarding the online persona may not comprise any personally identifiable information. In some instances, relevant user information regarding the online persona may be captured, recorded, and/or kept track of with aid of one or more channels or websites. In some instances, relevant user information regarding different online personas may be collected across a plurality of different channels or websites. In some instances, a segment of relevant user information may be transmitted to one or more desired advertising platforms, e.g., to be associated with the advertising platform-specific IDs.

In some instances, the different online personas may be divided into different experimental groups. The experimental groups may be as substantially described herein. In some instances, the division of the experimental groups may be based on predetermined criteria. For example, the division of experimental groups may be based on based on a location (e.g., website) the relevant user information regarding the online persona was captured, frequency of use of the location, and the like. In some instances, the division of experimental groups may be based a plurality of different factors.

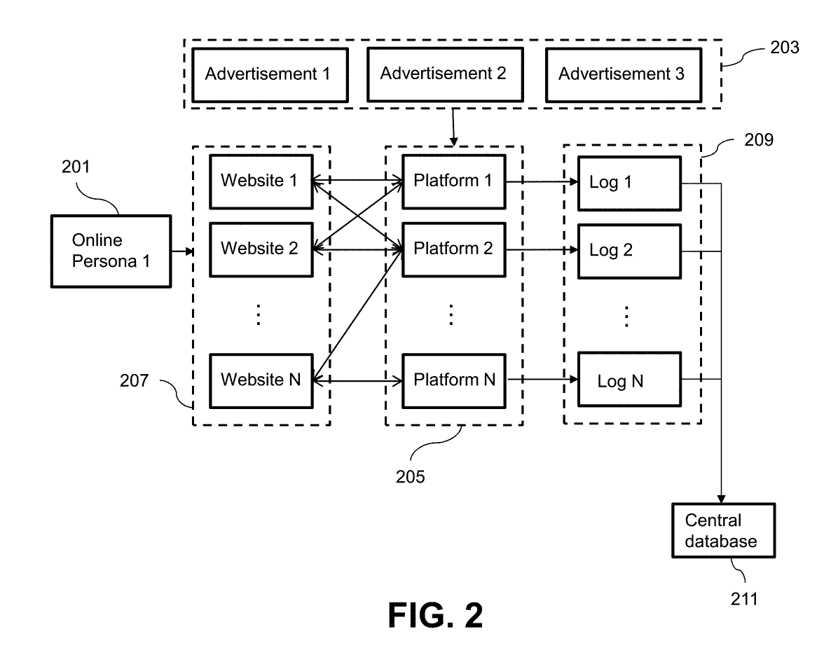

An advertising campaign may be set up to deliver a digital advertising to the online personas or target user. The online personas may be those that had been matched to the target individual within a list as described in FIG. 1. In some instances, the online personas may be those that had been targeted without being association with target individuals in a list. Each online persona may be associated with a target user (e.g., a real world user). FIG. 2 illustrates a schematic of an advertising campaign set up for an online persona (e.g., a target user), in accordance with embodiments. For example, each advertising platform may evaluate potential opportunities for presenting advertisements to an online persona 201 (e.g., an ad impression). The online persona may be tied to, or be associated with, a platform-specific ID, previously referred to herein. In some instances, the online personas may be determined to be a target individual in a list. Alternatively, the online persona may not be associated with any specific target individuals identified in a list. In some instances, the online persona may be determined to be an individual within the list or within an audience group, but it may not be possible to link the online persona to a specific target individual. The determination may be made according to presence or absence of the anonymous segment, or specific online-cookies. In some instances, if an ad impression's ID matches the segment of ID transmitted by the matching partner (e.g., online-cookies), the advertising platform may be configured to bid for presentation of an advertisement. In some instances, if an ad impression's ID matches previously identified relevant user information, the advertising platform may be configured to bid for delivery of an advertisement.

Any type of advertisements 203 may be configured to be delivered to the online persona (e.g., target user). The advertisements may be delivered to the target user via any given medium. In some instances, video advertisements may be delivered to the target user. The video advertisements may be stand-alone, or may be appended to a content a user has selected for viewing. For example, pre-roll, mid-roll, or post-roll video advertisements may be delivered to the online persona. As used herein, a pre-roll video advertisement may refer to an advertisement that plays before a content the user has selected. A mid-roll video advertisement may refer to an advertisement that plays during a content the user has selected. A post-roll video advertisement may refer to an advertisement that plays after a content the user has selected. In some instances, advertisements may be delivered to the target individual in any other given format, e.g., in the form of a banner, in a pop-up, etc.

The advertisements may be delivered using a plurality of different advertising platforms 205. Advertising platforms as referred herein may aid advertisers or agencies manage, buy, and/or deliver advertisements. In some instances, the advertising platform may aid advertisers or agencies keep track of various data or information regarding the advertisements or users to whom the advertisements are delivered to. In some instances, the advertising platform may receive a request or instructions to cause advertisements to be delivered to the online personas, or target users. Utilizing the advertising platform, advertisements may be delivered across a plurality of different channels or websites 207. A single advertising platform may be used to deliver advertisements across a plurality of different channels or websites. Alternatively, a plurality of different advertising platforms may be used to deliver advertisements across a plurality of different channels or websites.

Delivering advertisements across a plurality of different channels may increase advertisement recall and amplify persuasive effect of advertisements. In some instances, utilizing a plurality of different advertising platforms to deliver the advertisements across different channels may further enhance advertisement recall and persuade users by expanding the number of ways possible to reach the target users. The advertisements may be delivered across a plurality of different devices, e.g., desktop computers, laptops, smart phones, PDAs, etc. In some instances, pre-roll video advertisements may be delivered to the online personas across a plurality of different websites and/or a plurality of different devices utilizing (e.g., submitting bids on) a single advertising platform. In some instances, pre-roll video advertisements may be delivered to a targeted user across a plurality of different websites and/or a plurality of different devices utilizing (e.g., submitting bids on) a plurality of different advertising platforms. For example, the online persona may browse a website and select a video to be viewed. A platform may detect an opportunity for an ad impression. In some instances, if an ad impression's ID matches the segment of ID transmitted by the matching partner, the advertising platform may be configured to bid for presentation of an advertisement. The advertisement may be further delivered if the bid is the highest bid for the particular advertisement impression.

Different marketing experiments may be designed for the different experimental groups, previously described herein. In some instances, different advertisements may be delivered to the different groups. For example, a first group may be configured to receive advertisement A while a second group may be configured to receive a different advertisement B. In some instances, advertisements may be delivered to the different groups through different mediums. For example, a first group may be configured to receive pre-roll video advertisements while a second group may be configured to receive pop-up advertisements or advertisements in a banner. In some instances, different groups may be configured to receive advertisements on different websites. For example, a first group may be configured to receive advertisements on a first website (e.g., youtube) while a second group may be configured to receive advertisements on a second website (e.g., Hulu).

In some instances, a different number of advertisements may be delivered to the different groups. For example, a first group may be configured to receive 10 advertisements throughout an advertising campaign while a second group may be configured to receive 50 advertisements throughout an advertising campaign. The number of advertisements the different experimental groups may be configured to receive may be equal to, or more than about 1, 5, 10, 15, 20, 25, 30, 35, 40, 45, 50, 100, 200, 500, or 1000 advertisements. In some instances, a different overall length of advertisements may be delivered to the different experimental groups. For example, a first group may be configured to receive 100 seconds worth of advertisements throughout an advertising campaign while a second group may be configured to receive 500 seconds worth of advertisements throughout an advertising campaign. The length of advertisements the different experimental groups may be configured to receive may be equal to or more than about 10, 15, 30, 60, 100, 200, 300, 400, 500, 750, 1000, 2000, 5000, or 10000 seconds of advertisements.

In some instances, advertisements may be delivered to the different groups at a different frequency, or the desired advertising platform may be configured to bid on the advertisement impressions at a different frequency for the different experimental groups. For example, a first group may be configured to receive an advertisement no more than once every day while a second group may be configured to receive an advertisement no more than once every week. For example, an advertising platform may be configured to bid on an advertisement impression for target user within the first group at every opportunity while the advertising platform may be configured to bid on an advertisement impression for target user within the second group at every other opportunity. The frequency as referred to herein may be equal any frequency, e.g., presentation of an advertisement or bid on an impression relative to an absolute scale (e.g., no more than once every minute) or relative to the number of advertisement impressions available (e.g., no more than once every ad impression available). In some instances, the different experimental groups may comprise a control group to which no advertisement is delivered. The different marketing experiments may be configured to measure an effectiveness of the advertising campaign for the different experimental groups.

A progression of the advertising campaign and/or the marketing experiment may be tracked. For example, ad server log files 209 may be received from each of the desired advertising platforms. The ad server log files may be received in any frequency or interval. For example, the ad server files may be received every hour, every 6 hours, every 12 hours, every day, every week, or every month. The ad server log file may contain data organized by a primary key of an anonymous user (e.g., the advertising platform specific ID) and a record of each ad impression that the anonymous user has received over a period of time. In some instances, although the anonymous user may not be identifiable (e.g., there is no PII within the primary key), it may be possible to determine whether the key corresponds to a person within the list of target individuals via the segment of anonymous ID.

Additional information regarding advertisements viewed by the anonymous target may be gathered and/or tracked. In some instances, for how long the advertisements are actually viewed by the anonymous target may be tracked. In some instances, when and whether target individuals stop watching advertisements may be tracked. For example, data regarding when the anonymous target mutes an advertisement or jumps to another window while the advertisement is being played in the background may be tracked. Tracking of the additional information may enable the determination regarding what type of creative actually holds people's attention. Tracking of the additional information may provide a more holistic overview of advertisements that grabs a user's attention. Tracking of the additional information may aid in optimizing advertisements for screen time rather than impressions.

An overall progression of the advertising campaign and/or the marketing experiment may be tracked across a plurality of different advertising platforms 205. For example, ad server log files from the plurality of different advertising platforms may be received. The plurality of different advertising platforms may comprise at least 2, 3, 4, 5, 6, 7, 8, 9, 10 or more different advertising platforms. Each of the ad server log files may be joined in an Extract, Transform, and Load (ETL) process that cleanses the data and joins it with other data sources to provide additional information on the type of creative a user saw. In some instances, a central database 211 may be provided for reporting, cleaning, and combining of the various ad server log files. For example, the central database may be configured to parse data from each of the advertising platforms each day and aggregate it together with additional information, e.g., website activity and transaction data.

According to the tracked data (e.g., progression of advertising campaign), a survey may be caused to be delivered to the online persona. In some instances, a survey may be caused to be delivered to the online persona (e.g., target user) according to a set criteria. In some instances, the survey may be delivered after completion of the advertising campaign and/or the marketing experiment. For example, the survey may be delivered after a set number of advertisement impressions have been delivered to the primary key (e.g., advertising platform specific user ID). In some instances, the survey may be delivered after a set number of advertisement impressions have been delivered to the online persona across a plurality of different advertising platforms according to numbers tracked in the central database. In some instances, the survey may be delivered after about 2, 4, 5, 10, 20, 30, 40, 50, 60, 70, 80, 90, or 100 ad impressions or more have been delivered to the primary key. In some instances, the survey may be delivered after about 2, 4, 5, 10, 20, 30, 40, 50, 60, 70, 80, 90, or 100 ad impressions or more have been delivered to the online persona, e.g., across a plurality of primary keys linked to a single online persona across different advertising platforms.

In some instances, the survey may be delivered after a set length of advertisement impressions have been delivered to the primary key. In some instances, the survey may be delivered after a set length of advertisement impressions have been delivered to the online persona across a plurality of different advertising platforms according to data tracked in the central database. In some instances, the survey may be delivered after about 10, 15, 30, 60, 100, 200, 300, 400, 500, 750, 1000, 2000, 5000, or 10000 seconds of advertisement impressions have been delivered to the primary key. In some instances, the survey may be delivered after about 10, 15, 30, 60, 100, 200, 300, 400, 500, 750, 1000, 2000, 5000, or 10000 seconds of advertisement impressions have been delivered to the online person, e.g., across a plurality of primary keys linked to a single online persona across different advertising platforms.

In some instances, the survey may be delivered after a set length of advertisement impressions have been viewed by the primary key. In some instances, the survey may be delivered after a set length of advertisement impressions have been viewed by the online persona across a plurality of different advertising platforms according to data tracked in the central database. In some instances, the survey may be delivered after about 10, 15, 30, 60, 100, 200, 300, 400, 500, 750, 1000, 2000, 5000, or 10000 seconds of advertisement impressions have been viewed by the primary key. In some instances, the survey may be delivered after about 10, 15, 30, 60, 100, 200, 300, 400, 500, 750, 1000, 2000, 5000, or 10000 seconds of advertisement impressions have been viewed by the online persona, e.g., across a plurality of primary keys linked to a single online persona across different advertising platforms.

The length of advertisement impressions viewed by the primary key may be different from the length of advertisement impressions delivered. For example, it may be possible to designate an advertisement impression as being delivered, but not viewed by a primary key or online persona. For example, it may be possible to tract whether an advertisement is being viewed by monitoring a browser activity of a user. In some instances, the advertisement impressions may be designated as being viewed if it is the primary window open on a screen, e.g., unobstructed by other applications or browsers. In some instances, the advertisement impressions may be designated as being viewed if the browser in which the advertisement impression is delivered is not minimized. In some instances, the advertisement impressions may be designated as being viewed if a cursor (e.g., mouse cursor) remains on the browser in which the advertisement impression is delivered. The length of advertisement impressions viewed by the primary key, or online persona may be equal to or less than the length of advertisement impressions delivered to the primary key or online persona.

Different set criteria may exist for each of the different experimental groups. For example, a survey may be caused to be delivered to individuals within a first group after about 10 ad impressions have been delivered while a survey may be caused to be delivered to a second group after about 50 ad impressions have been delivered. The survey may be in the form of a video embedded survey, e.g., an interactive survey embedded within a video. In some instances, the survey may be presented to the anonymous target browsing a website in lieu of a video advertisement. For example, the survey may be presented in place of a pre-roll video advertisement. In some instances, the survey may be presented to the target user after delivery of a video advertisement. The survey may be delivered by utilizing any of the plurality of advertisement platforms 205, previously described herein.

In some instances, a primary key to which a survey has been delivered may no longer be eligible to receive surveys. In some instances, an online persona to which a survey has been delivered may no longer be eligible to receive surveys. In some instances, an online persona may be eligible to receive surveys across each advertising platform, or for each primary key.

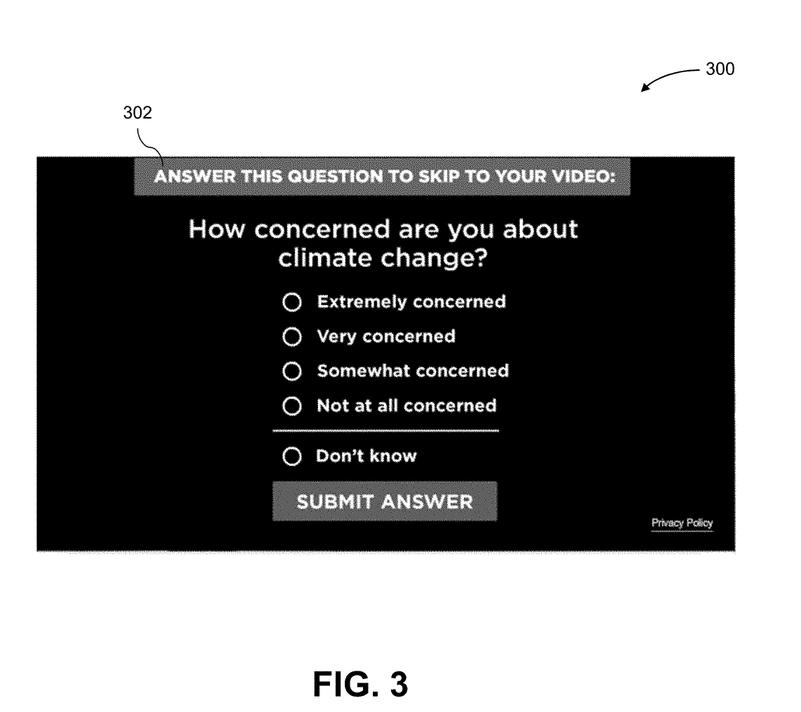

FIG. 3 illustrates an exemplary survey 300 presented in a pre-roll video, in accordance with embodiments. The survey may comprise a prompt, a question, and/or a list of potential answers. While survey 300 shows a monotone colored background, the survey as described herein may comprise any kind of background, e.g., including pictures, figures, and/or colors. In some instances, the background may be matched to a relevant question being asked. For example, a question associated with climate change may comprise a background containing pictures of nature, or the color green. The matching of the background to a question may increase advertisement recall and amplify the persuasive effect of advertisements.

The prompt 302 may be presented in any location within the survey. For example, the prompt may be located on a top, left, bottom, or right side of the survey. Alternatively, no prompt may be presented within the survey. In some instances, the wording of the questions, the answer choices, or both may be rotated. In some instances, the wording of the questions, the answer choices, or both may be randomized. The answers input by the anonymous user (e.g., key, online persona, etc) may be logged and attributed to specific anonymous user IDs. Any user who watches pre-roll videos online may be accessible to be reached via the surveys described herein. Accordingly, the survey may have high response rate and lack self-selection bias. The logged survey answers may be attributed to specific audience groups, e.g., the different experimental groups. Various data regarding the survey results may be calculated to determine an effectiveness of the advertising campaign. Various data regarding the survey results may provide insight regarding persuasive metrics of an advertising campaign. The gathered data may be housed in a reporting dashboard that provides analysis regarding the advertising campaign, e.g., campaign impact, creative testing and audience composition. The survey may be configured to measure persuasion metrics. For example, results of surveys presented to different experimental groups may be compared in order to determine an effectiveness of an advertisement campaign. For example, results of surveys delivered to a control group to which no advertisement had been delivered may be compared to results of surveys delivered to a group to which advertisements had been delivered in order to determine the persuasion metrics. The survey may be configured to measure factors such as message recall, issue favorability, and intent to take action.

In some instances, a survey may comprise a plurality of questions and a plurality of answers. In some instances, multiple surveys (e.g., with a question and answers) may be presented to the online persona on a single screen (e.g., in a pre-roll video). In some instances, a sequence of surveys may be presented to the online persona (e.g., in a pre-roll video). Each response given for the multiple, or sequence of surveys may be attributed to the online persona and/or primary key of the online persona.

The presentation of a survey taking into account the aggregated data within the central database may aid in determining an overall effectiveness of an advertising campaign measured across a plurality of different platforms and aid in acquisition of persuasion metrics that is meaningful. For example, the aggregated data may reflect how people actually consume information in the real world and are persuaded over time, over compounding information. The aggregated data make take into account a set number of advertisements (e.g., or a set length of advertisements) delivered across a plurality of different channels and websites. The incorporation of a survey within a pre-roll video may ensure a high response rate and mitigate against self-selection bias and aid in acquisition of answers from any target individual exposed to the advertisements over time, across the plurality of channels.

Media (e.g., advertisements) may be optimized based on the surveys. For example, future advertisements may be optimized by various factors, e.g., type, length, frequency, number of advertisements, websites on which advertisements are presented, etc based on the surveys and/or analysis done regarding the surveys. In some instances, recommendations and forecasts for how changing a media mix would impact survey results may be provided. In some instances, advertisements may be optimized for each of the different experimental groups. In some instances, the advertisements may be optimized based on the audience composition of the group. For example, demographic information may be appended to anonymous IDS (e.g., the anonymous segments) or the different experimental groups. In some instances, survey movement by subgroups may be analyzed and displayed.

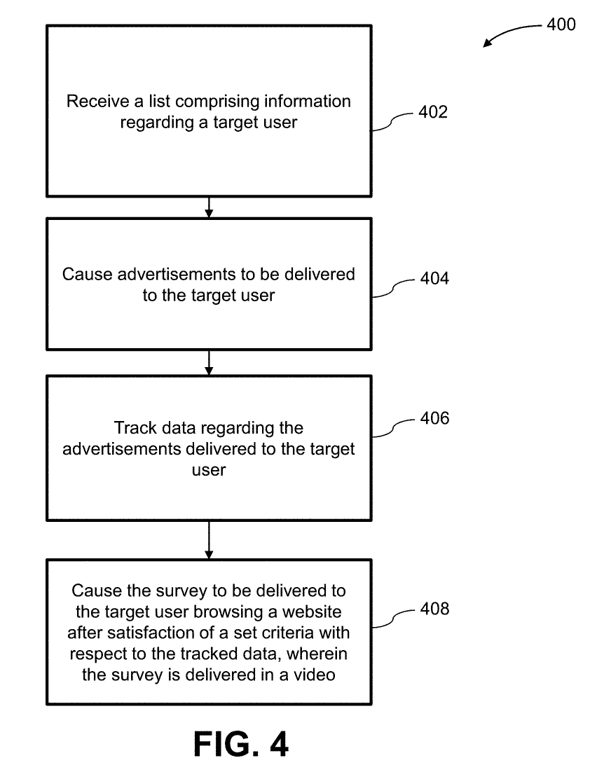

FIG. 4 illustrates a method 400 of delivering a survey, in accordance with embodiments. In step 402, a list comprising information regarding a target user is received as described above (e.g., from a client). The list may comprise information regarding a plurality of target users. In some instances, the list may comprise personally identifiable information (PII) of the target user as previously described herein. For example, the list may comprise a name or address of the target user, an email address of the target user, or demographic information of the target user. The list may be divided into a plurality of different experimental groups. For example, the plurality of target user may be divided into a plurality of different experimental groups, e.g., randomly, based on demographic information, etc. The list may be matched to online personas and/or advertising platform-specific IDs. In some instances, the list may be matched to a plurality of advertising platform-specific IDs, substantially as previously described herein.

An advertising campaign may be set up to deliver targeted advertisements to the target user. In some instances, different advertising campaigns may be set up to deliver advertisements to the plurality of different experimental groups. The different advertisement campaigns may differ in a number of advertisements, a type of advertisements, or a sequence of advertisements given to the target user, and the like, substantially as described herein.

In step 404, one or more processors may cause targeted advertisements to be delivered to the target user (e.g., online personas that have been matched to target individuals). For example, one or more requests may be sent to an advertising platform, e.g., using the internet. In some instances, the request may be sent to a plurality of different advertising platforms. The request may comprise instructions to cause advertisements to be delivered to the target user. For example, the advertising platform may be capable of recognizing the target user when the user is browsing a website, e.g., after the target user has been matched as described herein.

For example, a targeted individual may browse the web online. The website being browsed may comprise space available for an advertisement (e.g., ad space). In some instances, the targeted user may select a video content to be played online (e.g., a youtube video). If the individual is identified as being a target individual (e.g., via the anonymous ID segment, previously described herein, a targeted advertisements may be caused to be delivered to the target individual. For example, an ID of each ad impression may be checked against a segment of user IDs provided by the matching partner. The advertising platform may be configured to bid on an ad impression when the ad impression's user ID matches the segment of the user ID transmitted by the matching partner. If the highest bid is placed, the impression may be won and the targeted advertisement may be caused to be delivered to the target user.

The targeted advertisements may be delivered via any given medium, e.g., in a video, in a banner, etc. In some instances, the advertisement may be delivered as a pre-roll video advertisement. In some instances, the targeted advertisement may be in a form of mid-roll video advertisement or a post-roll video advertisement. The targeted advertisements may be caused to be delivered across one or more websites. In some instances, the targeted advertisements may be caused to be delivered across a plurality of different websites. For example, the targeted advertisements may be caused to be delivered across 2, 3, 4, 5, 6, 7, 8, 9, 10, 15, 20, 30, 40, 50, or more different websites. The targeted advertisements may be delivered using one or more advertising platforms. In some instances, the targeted advertisements may be delivered using a plurality of different advertising platforms. For example, the targeted advertisements may be delivered using 2, 3, 4, 5, 6, 7, 8, 9, 10, 15, 20, 30, 40, 50, or more different advertising platforms.

In step 406, data regarding the advertisements delivered to the target user may be tracked. For example, ad server log files may be received from each of the advertising platforms. In some instances, data regarding the advertisements delivered to the target user may be tracked across a plurality of different advertising platforms. A target user may be identified from within the ad server log files, e.g., based on a segment of anonymous user ID. The segment may comprise no personally identifiable information and may be anonymous. The segment may comprise no personally identifiable information but may comprise information to indicate that the ID is associated with a target user, or an individual within the list. In some instances, the segment may comprise information to indicate that the ID is associated with an individual within an experimental group. In some instances, the data regarding advertisements delivered to the target user may comprise data regarding desired (e.g., pre-selected) advertisements delivered to the target user. In some instances, the data regarding advertisements delivered to the target user may comprise data regarding video advertisements delivered to the target user. In some instances, the data regarding advertisements delivered to the target user may comprise data regarding pre-roll video advertisements delivered to the target user.

In some instances, the method 400 may further comprise cleaning the tracked data. In some instances, the method may further comprise joining the tracked data with additional data, e.g., additional advertising platforms or information from other sources. For example, unnecessary data from the ad server log files may be discarded and aggregated with ad server log files from other advertising platforms. In some instances, data from each of the different ad server log files may be aggregated in a central database. The data tracked may be cleaned and joined in an ETL process as previously described herein. In some instances, additional information may be tracked. The additional data may provide additional information on various parameters regarding the advertisement viewed by a user, e.g., a type of advertisement, a length of the advertisement viewed, etc.

In step 408, the survey may be caused to be delivered to the target user browsing a website. The survey may be caused to be delivered after satisfaction of a set criteria. In some instances, the set criteria may comprise a set period of time. For example, the survey may be delivered after a set period of time has elapsed since delivery of a targeted advertisement. The set period of time may equal to or more than about a day, 2 days, 3 days, 5 days, 7 days, 2 weeks, 4 weeks after delivery of the targeted advertisement. In some instances, the set criteria may comprise a set number of advertisements or a set length of advertisements delivered to the target user, substantially as described elsewhere.

The survey may be as previously described herein. The survey may be embedded within a video. In some instances, the survey may be delivered in place of a pre-roll video advertisement that was set to be delivered to the user. The answer to the surveys may be logged. In some instances, the answer to the survey may be associated with an anonymous target. In some instances, the answer to the survey may be attributed to an experimental group.

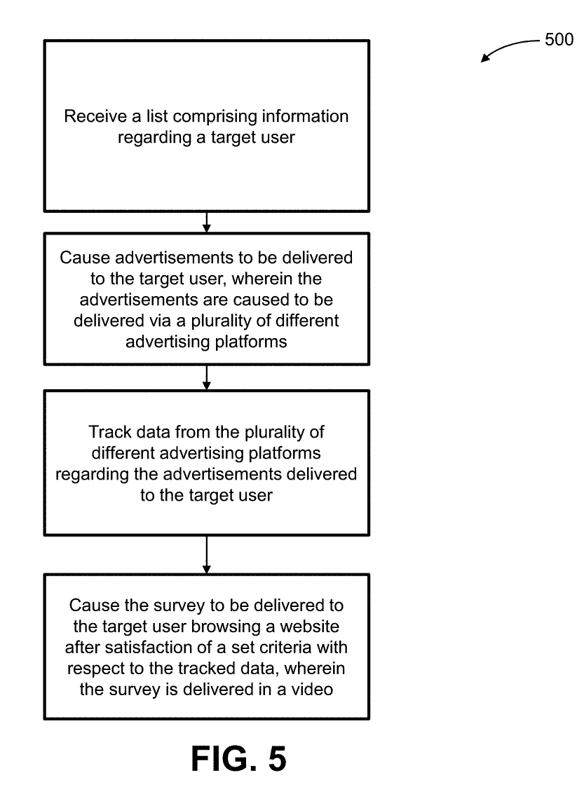

FIG. 5 illustrates a method 500 for delivering a survey based on data tracked across a plurality of different platforms, in accordance with embodiments. In some instances, a non-transitory computer-readable medium storing instructions executable by one or more processors of a processing device, which upon such execution cause the one or more processors to perform a method 500 may be provided. The non-transitory computer readable medium may receive a list, wherein the list comprises information regarding a target user; track data regarding advertisements delivered to the target user, wherein the advertisements are delivered to the target user across a plurality of different advertising platforms; and cause the survey to be delivered to the target user browsing a website, wherein the survey is delivered after satisfaction of a set criteria, and wherein the survey is embedded within a video.

In some instances, a system for delivering a survey may be provided. The system may comprise: one or more processors, individually or collectively configured to: receive a list, wherein the list comprises information regarding a target user; track data regarding advertisements delivered to the target user, wherein the advertisements are delivered to the target user across a plurality of different advertising platforms; and cause the survey to be delivered to the target user browsing a website, wherein the survey is delivered after satisfaction of a set criteria, and wherein the survey is embedded within a video.

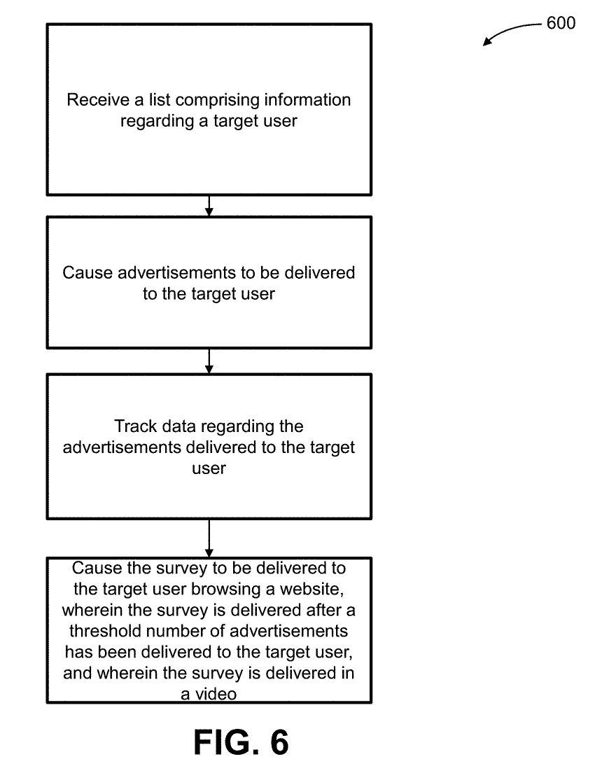

FIG. 6 illustrates a method 600 for delivering a survey after a threshold number of advertisements have been delivered to the target user, in accordance with embodiments. In some instances, a non-transitory computer-readable medium storing instructions executable by one or more processors of a processing device, which upon such execution cause the one or more processors to perform the method 600 may be provided. The non-transitory computer-readable medium may be configured to receive a list, wherein the list comprises information regarding a target user; track data regarding advertisements delivered to the target user; and cause the survey to be delivered to the target user browsing a website, wherein the survey is delivered after a threshold number of advertisements has been delivered to the target user, and wherein the survey is embedded within a video.

In some instances, a system for delivering a survey may be provided. The system may comprise: one or more processors, individually or collectively configured to: receive a list, wherein the list comprises information regarding a target user; track data regarding advertisements delivered to the target user; and cause the survey to be delivered to the target user browsing a website, wherein the survey is delivered after a threshold number of advertisements has been delivered to the target user, and wherein the survey is embedded within a video.

An effectiveness of the advertising campaign may be measured based on a response of the anonymous user to the survey, substantially described throughout. The anonymous user, or the online persona, may be identified as being an individual within the list of targeted individuals, or as being an individual within an audience group. The survey results may be analyzed. The survey results may provide insight into how a target user, or a specific group of users (e.g., experimental group) may be persuaded over a plurality of different channels over various factors such as frequency, targeting, length, and numbers of advertisements shown. Based on the analysis, advertisements may be further optimized and tailored to specific audience groups.

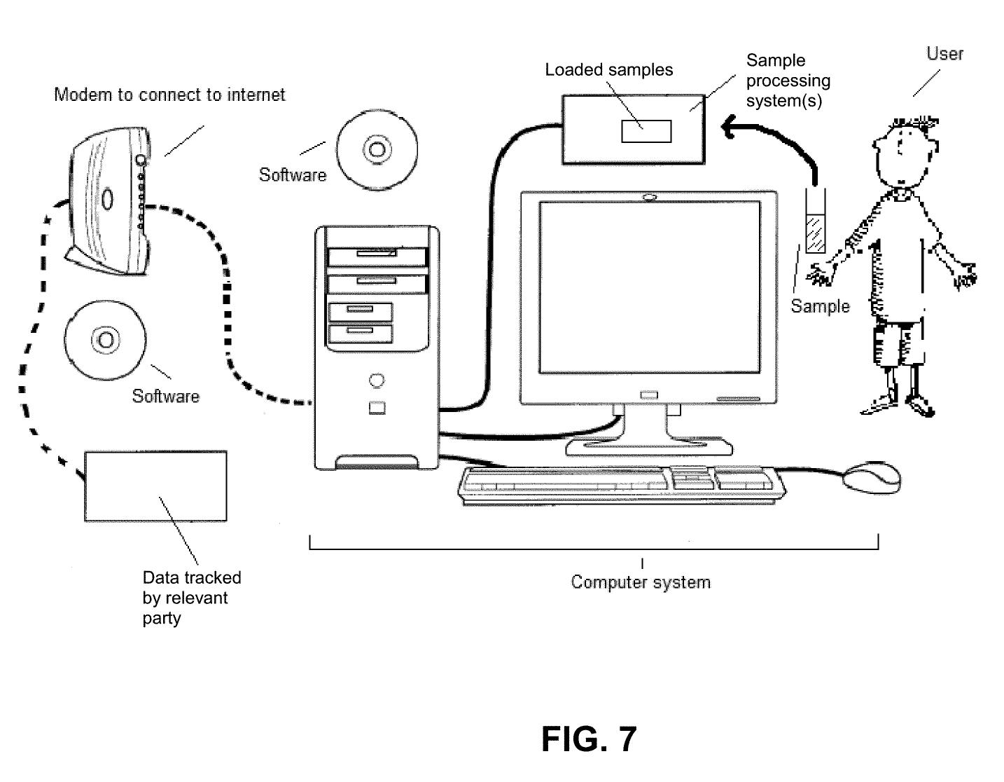

FIG. 7 illustrates a video survey delivered to an individual, in accordance with embodiments. A user may browse a website on a computer system that is connected to the internet via a modem. In some instances, the user may be a target user as identified in a list. The user may have an online persona. For example, the user may have log in information associated with certain websites. For example, the computer may comprise cookies acquired by visiting websites. The user may browse a plurality of different websites over time. At some of the websites, the user may receive an advertisement, e.g., from an advertising campaign. In some instances, the advertisements may be delivered to the user as a result of an advertising platform bidding on one or more ad impressions. In some instances, the advertising campaign may utilize a plurality of different advertising platforms in delivering the advertisements. In some instances, the advertisements may be delivered in a pre-roll video. Data regarding the user and/or the advertisements may tracked by a relevant party, substantially as described above. Based on the tracked data, a survey may be delivered to the user. In some instances, the survey may be delivered in a pre-roll video over the computer system.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method of delivering a survey in a video to a target user browsing a website, the method comprising:
receiving a list at a server, wherein the list comprises information regarding the target user;
causing advertisements to be delivered to the target user, wherein the advertisements are caused to be delivered to the target user via a plurality of different advertising platforms;
tracking data from the plurality of different advertising platforms regarding advertisements delivered to the target user; and
causing the survey to be delivered to the target user browsing the website after satisfaction of a set criteria with respect to the tracked data, wherein the survey is delivered in the video.

2.-6. (canceled)

7. The method of claim 1, wherein data regarding advertisements delivered to the target user is tracked based on advertisements delivered to an anonymous user ID associated with the target user.

8.-15. (canceled)

16. The method of claim 1, wherein the tracked data comprises data regarding video advertisements delivered to the target user.

17. The method of claim 16, wherein the tracked data comprises data regarding a length of video advertisements viewed by the target user.

18. The method of claim 1, wherein the survey is delivered in an interactive pre-roll video.

19. The method of claim 1, wherein the set criteria is a set period of time after delivery of at least one advertisement.

20. The method of claim 1, wherein the set criteria is a total length of advertisements viewed by the target user.

21.-22. (canceled)

23. The method of claim 1, wherein the list comprises information regarding a plurality of target users.

24. The method of claim 23, further comprising dividing the plurality of target users into a plurality of different audience groups.

25. The method of claim 24, wherein a different advertisement campaign is delivered to each of the different audience groups.

26. The method of claim 25, wherein the different advertisements campaigns differ in a number of advertisements, a type of advertisements, or a sequence of advertisements delivered to the target user.

27. The method of claim 24, further comprising organizing the tracked data by the different audience groups.

28. The method of claim 24, further comprising measuring an effectiveness of the advertisement campaign delivered to each of the different audience groups based on persuasion metrics comprising message recall, issue favorability, and intent to take action.

29. The method of claim 1, wherein the survey contains a question and a list of potential answers.

30. The method of claim 1, wherein questions or answers within the survey are configured to be rotated or randomized.

31. The method of claim 1, further comprising receiving a response to the survey.

32. The method of claim 31, further comprising measuring an effectiveness of the advertisement campaign based on a response of the target user to the survey.

33. The method of claim 31, further comprising associating the answer to the survey with a user ID associated with the target user.

34. (canceled)

35. The method of claim 31, further comprising attributing the response to an audience group.

36. (canceled)

37. A system for delivering a survey in a video to a target user browsing a website, the system comprising:
one or more processors, individually or collectively configured to:
receive a list at a server, wherein the list comprises information regarding the target user;
cause advertisements to be delivered to the target user, wherein the advertisements are caused to be delivered to the target user via a plurality of different advertising platforms;
track data from the plurality of different advertising platforms regarding advertisements delivered to the target user; and
cause the survey to be delivered to the target user browsing the website after satisfaction of a set criteria with respect to the tracked data, wherein the survey is delivered in the video.

38.-75. (canceled)
